(19) United States
(12) Patent Application Publication
(10) Pub. No.: US 2023/0366326 A1
(43) Pub. Date: Nov. 16, 2023

(54) METHODS AND APPARATUS TO HEAT ROTOR BLADES

(71) Applicant: General Electric Company Polska sp. z o.o., Warsaw (PL)

(72) Inventor: Jakub Kulecki, Warsaw (PL)

(21) Appl. No.: 17/980,365

(22) Filed: Nov. 3, 2022

(30) Foreign Application Priority Data
May 10, 2022 (PL) P.441138

(51) Int. Cl. F01D 25/02; H05B 1/02; H05B 3/18; H02K 21/28

(52) U.S. Cl. CPC F01D 25/02; H05B 1/023; H05B 3/18; H02K 21/28; H05B 2214/02

(57) ABSTRACT

Methods, apparatus, systems, and articles of manufacture are disclosed to heat rotor blades. An example blade heating apparatus includes a stationary magnet; a solenoid to rotate around or inside the stationary magnet, the rotation to generate electricity using the solenoid; and a heating element embedded in a rotor blade, the heating element to increase a temperature of the rotor blade using the electricity to mitigate icing.

### FIELD OF THE DISCLOSURE

It is noted that this patent claims priority from Polish Patent Application Number P.441138, which was filed on May 10, 2022, and is hereby incorporated by reference in its entirety.

### FIELD OF THE DISCLOSURE

This disclosure relates generally to rotor blades and, more particularly, to methods and apparatus to remove ice from rotor blades.

### BACKGROUND

Rotor blades may be used in a variety of applications. In some applications, environmental conditions may lead to the accumulation of ice on or around the rotor blades. If unaddressed, ice accumulation may lead to loss of thrust/power, damage to the rotor blades, damage to a power source of the rotor blades, damage to an adjacent aircraft structure, and/or inaccurate readings associated with one or more of the rotor blades and its power source.

### BRIEF DESCRIPTION OF THE DRAWINGS

FIG. 1 is a block diagram of a first example implementation of a blade heating apparatus.

FIG. 2 is an illustrative example of a second example implementation of a blade heating apparatus.

FIG. 3 is an example implementation of a generator used in the second example implementation of the blade heating apparatus of FIG. 2.

FIG. 4 is a block diagram of the second example implementation of a blade heating apparatus of FIG. 2.

FIG. 5 is a block diagram of a third example implementation of an example blade heating apparatus.

FIG. 6 is a block diagram of the generator of FIG. 5.

FIG. 7 is a flowchart representative of example machine readable instructions and/or example operations that may be executed by example processor circuitry to implement the controller circuitry of FIG. 1.

FIG. 8 is a block diagram of an example processing platform including processor circuitry structured to execute the example machine readable instructions and/or the example operations of FIG. 7 to implement the controller circuitry of FIG. 1.

FIGS. 9A, 9B, and 9C are a first illustrative example of the fan rotor blade of FIG. 1.

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Many applications of rotor blades require high safety thresholds to operate. Example high safety threshold applications that use rotor blades include but are not limited to aircraft carrying passengers or cargo. In addition to reducing performance, ice accumulation on a rotor may present safety issues such as durability and degradation of control and handling characteristics. As a result, applications with a high safety threshold may implement solutions to remove or prevent ice accumulation.

Some previous solutions to remove or prevent ice accumulation on rotors focus on applying a de-icing fluid such as ethylene glycol or isopropyl alcohol. For applications including aircraft, such previous solutions may be inefficient in terms of cost of the fluid, time required to apply the fluid, and, in some examples, additional weight to carry on the vehicle.

Other previous solutions involve affixing heating elements to the surface of a rotor blade. To power the heating elements, electricity is provided to the heating element by rotating a magnet around or inside a stationary coil. Such previous solutions may alter the aerodynamic properties of the rotor due to the position of the heating element on the surface of the blade, which in turn may decrease the rotor's performance. Furthermore, providing electricity by rotating a magnet around a coil may be logistically difficult to implement due to the mechanical stresses involved in supporting the rotational movement of a large mass such as a magnet.

Example systems, methods, and apparatus disclosed herein heat a rotor blade. An example generator generates electricity by rotating a coil around or inside a stationary magnet. The electricity is provided to a heating element in the rotor blade to remove and/or prevent ice through increased temperature. The heating element may be embedded within the composite layers of a rotor blade so as to not affect the aerodynamic properties of the blade. Before reaching the heating element, the electricity may pass through an example switch that is opened or closed by example controller circuitry to enable or disable the heating element. The example controller circuitry may enable or disable the heating element based on a reading from sensor circuitry corresponding to the rotor blade and/or based on a signal from a cockpit. The circuit formed by the example generator, example switch, and example heating element may be electrically isolated from other circuits in an aircraft.

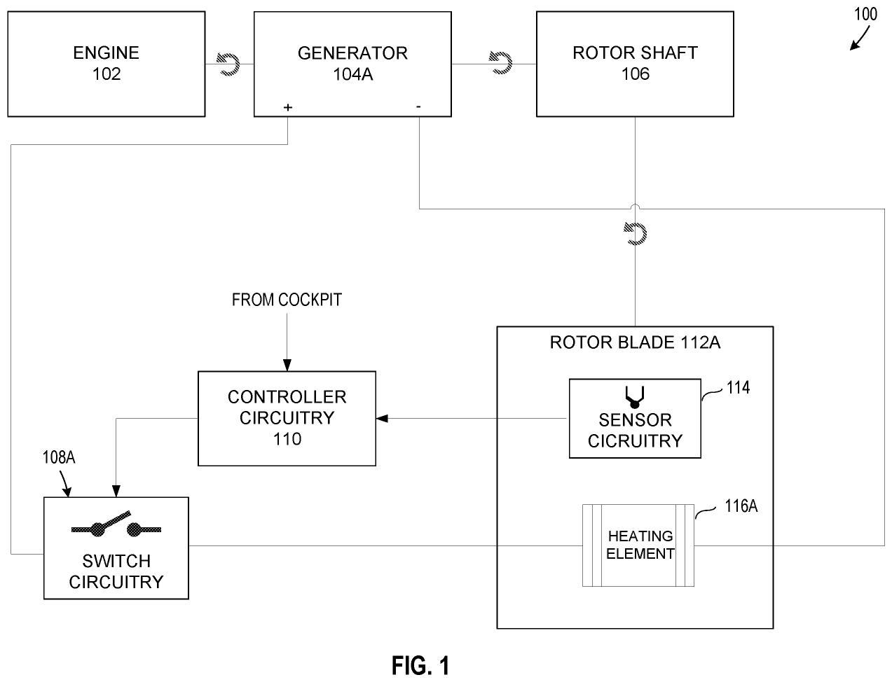

FIG. 1 is a block diagram of a first example implementation of an example blade heating apparatus. The example blade heating apparatus 100 includes an example engine 102, an example generator 104A, a rotor shaft 106, example switch circuitry 108A, example controller circuitry 110, and an example rotor blade 112A. The example rotor blade includes an example sensor circuitry 114 and example heating element 116A.

The example engine 102 of FIG. 1 converts one or more forms of energy into mechanical energy. In some examples, the example engine 102 is a turbojet engine. In such examples, energy stored in liquid fuel is converted into mechanical energy by combusting the fuel to form a high pressurized gas and rotate a turbine. In other examples, the example engine 102 may be a different type of engine.

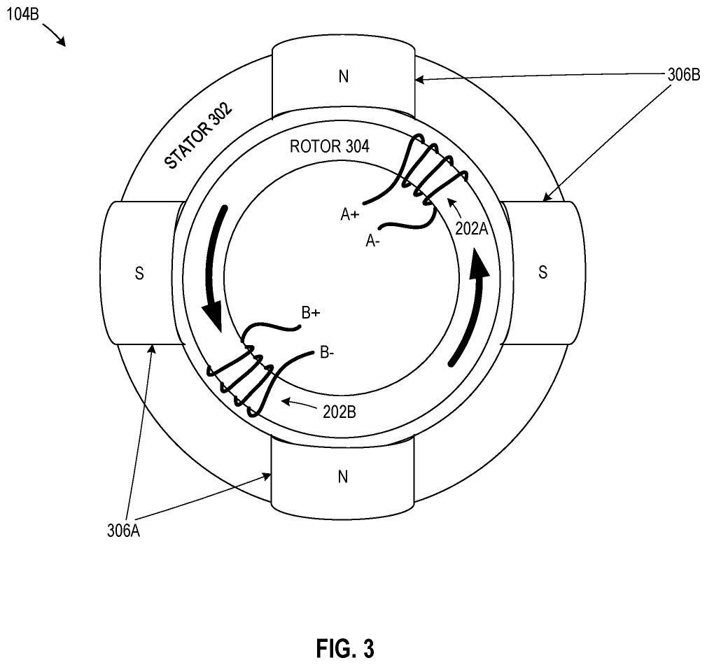

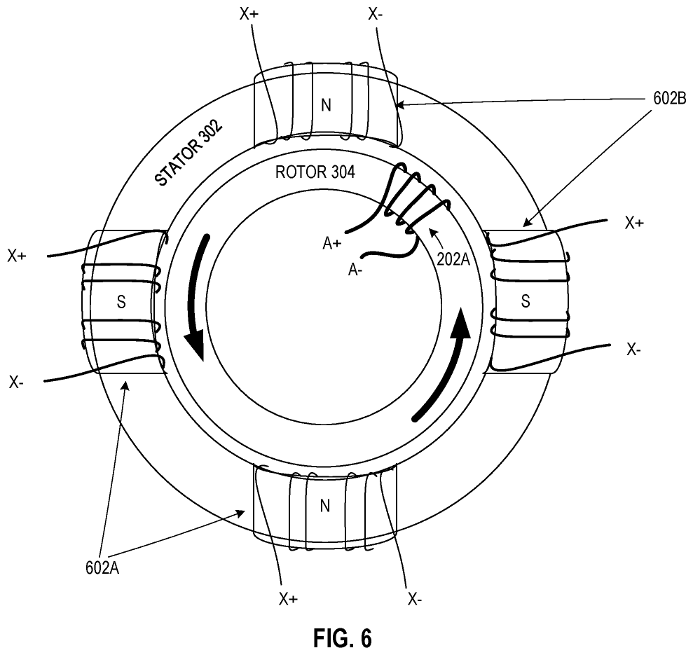

The example generator 104A of FIG. 1 generates electricity in the form of a current using the rotational energy produced by the example engine 102. In some examples, the generator 104A generates Direct Current (DC), which can be used directly by the heating element 116A. In other examples, however, the generator 104A may generate Alternating Current (AC). In such examples, the example blade heating apparatus 100 may (a) convert the AC to DC before providing the current to the heating element 116A or (b) construct the rotor blade 112A with a heating element 116A that uses AC. The example generator 104A provides the electricity to the switch circuitry 108A. The example generator 104A also provides the rotational energy to the rotor shaft 106. Example implementations of the generator 104A are explored further in FIGS. 3 and 6.

The example rotor shaft 106 of FIG. 1 transfers rotational energy between components of the example blade heating apparatus 100. The example rotor shaft 106 transfers rotational energy to the rotor blade 112A, and generates electricity in the example generator 104A due to relative movement of magnets and coils. In some examples, an additional or alternative rotor shaft may be used in FIG. 1 to transfer rotational energy from the engine 102 to the generator 104A.

The example rotor blade 112A receives rotational energy from the rotor shaft 106 and rotates around an axis of rotation. In some examples, the rotor blade 112A may also be referred to as a propellor, or an open rotor aircraft engine. The example rotor blade 112A may be one of a plurality of rotor blades that each receive rotational energy from the rotor shaft and rotate around the common axis of rotation. In such examples, one or more of the plurality of rotor blades may be implemented with an example sensor circuitry 114 and an example heating element 116A. The rotation of the plurality of rotor blades may generate lift and/or thrust used to steer the aircraft. The rotor may be a fan rotor, or a compressor rotor associated with the engine 102, or an open rotor, or a main rotor of a rotorcraft, or a tiltrotor aircraft. In some examples, the example engine 102, example rotor shaft 106, and example rotor blade 112A may be collectively referred to as components of a turboprop or turbofan engine, or as any other kind of an engine employing rotor blades.

The example switch circuitry 108A of FIG. 1 receives the electricity from the generator 104A. The example switch circuitry 108A has an open state and a close state. In the open state, current does not flow through the example switch circuitry 108A. In the closed state, current does flow through the example switch circuitry 108A. The example switch circuitry 108A may be any type of switch. The example switch circuitry 108A may change states in response to receiving a control signal. In some examples, the switch circuitry 108A may be a reed switch or any other kind of a remotely operated switch.

The example controller circuitry 110 of FIG. 1 provides a control signal to control the state of switch circuitry 108A. In some examples, the example controller circuitry 110 may determine whether the switch circuitry 108A is opened or closed based on a signal from a cockpit. In such examples, the signal from the cockpit may come directly from a user (e.g., a pilot) or be provided by another aircraft system. In some examples, the example controller circuitry 110 may additionally or alternatively determine whether the switch circuitry 108A is opened or closed based on one or more values provided by the example sensor circuitry 114. The example controller circuitry 110 may be implemented by any form of processor circuitry.

The example sensor circuitry 114 of FIG. 1 measures one or more properties corresponding to the rotor blade 112A. In some examples, the example sensor circuitry 114 provides one or more temperature values of the rotor blade 112A. In such examples, the temperature values may come from any region of the rotor blade 112A. In other examples, the sensor circuitry 114 may measure a different property. The example sensor circuitry 114 provides the measured values to the example controller circuitry 110. In some examples, the sensor circuitry 114 may additionally provide the measured values to other aircraft systems.

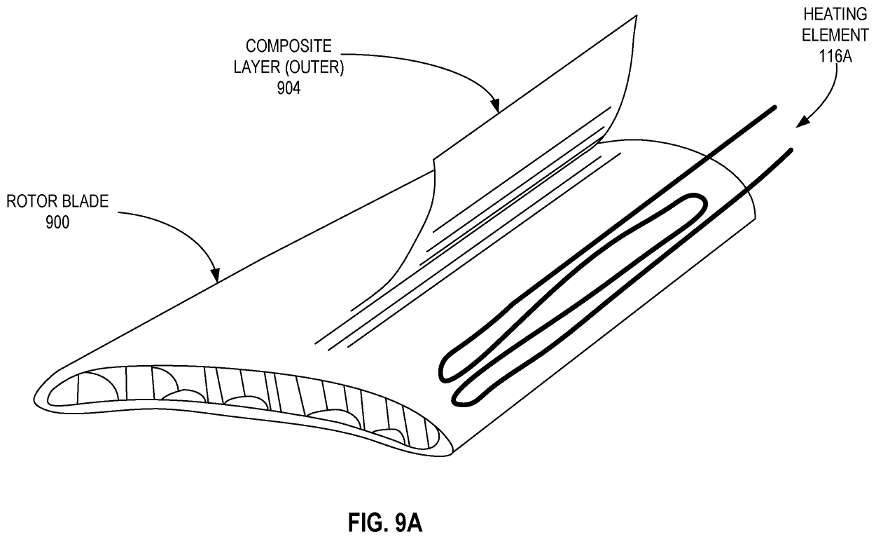

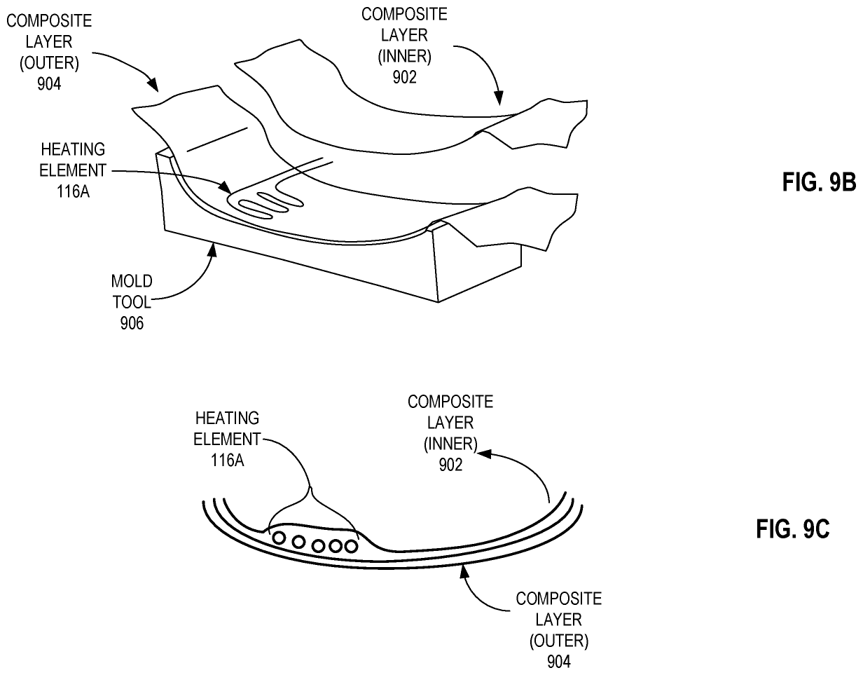

The example heating element 116A of FIG. 1 is any material or device that can generate a difference in temperature using electricity. When the exampled switch circuitry 108A is closed, current flows from the generator 104A to the switch circuitry 108A to the heating element 116A and back to the generator 104A, completing a circuit and heating the rotor blade 112A in the process. In some examples, the heating element 116A may be referred to as “powered on” when it receives current and “powered off” when it does not receive current. In some examples, the heating element 116A may be a heat strip or a heating mat. The heating element may be embedded within the rotor blade 112A. The heating element 116A is explored further in FIGS. 9A-9C.

The example blade heating apparatus 100 of FIG. 1 heats the example rotor blade 112A by providing current to the embedded heating element 116A. To power the heating element 116A, the example blade heating apparatus 100 of FIG. 1 generates electricity using rotational energy that is available from the engine 102 and is isolated from other aircraft circuitry. In some examples, the example sensor circuitry 114 and example heating element 116A may be implemented in, and the example rotor shaft 106 may connect to, an additional or alternative component of an aircraft engine. For example, an example blade heating apparatus 100, 200, 500 may provide heat to a spinner cone in addition to, or replacement of, the example rotor blade 112A.

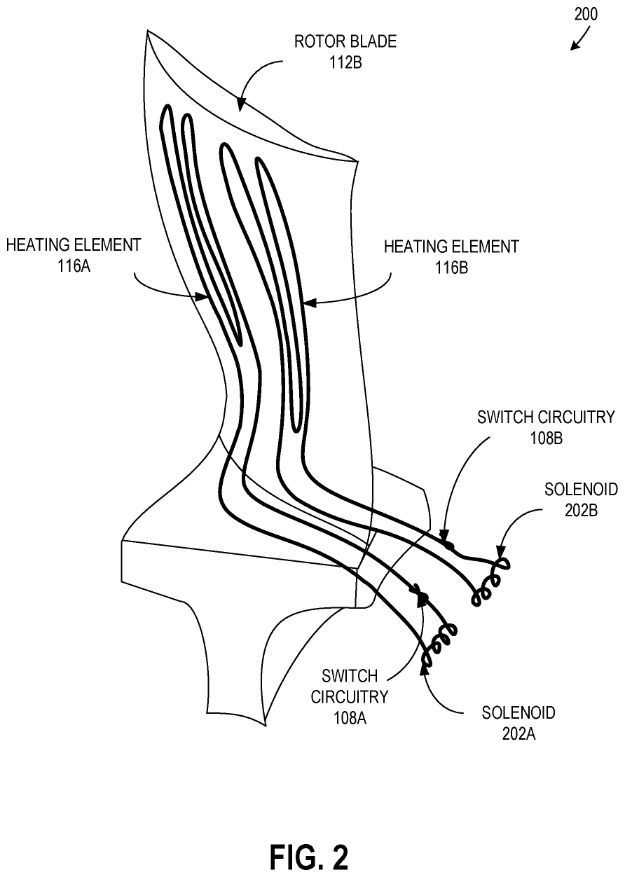

FIG. 2 is a second illustrative example of the example blade heating apparatus of FIG. 1. The example blade heating apparatus 200 of FIG. 2 includes an example first solenoid 202A, an example second solenoid 202B, example first switch circuitry 108A, example second switch circuitry 108B, an example rotor blade 112B, an example first heating element 116A, and an example second heating element 116B. FIG. 2 illustrates two example heating circuits for simplicity. Each heating circuit includes an example solenoid 202A, 202B, example switch circuitry 108A, 108B and example heating element 116A, 116B. The example blade heating apparatus 200, however, may include any number of heating circuits. Multiple, independently controlled heating circuits allow for increased granularity in the application of heat. Granular heat control allows the blade heating apparatus 200 to meet a variety of anti-icing requirements that may change based on environmental conditions or other factors.

The example first solenoid 202A and the example second solenoid 202B of FIG. 2 rotate around or inside of one or more stationary magnets 306A, 306B. This rotation is described further in connection with FIG. 3. Together, the first solenoid 202A, second solenoid 202B, and the one or more stationary magnets 306A, 306B may be collectively referred to as a generator 104B. The two solenoids allow the example blade heating apparatus 200 of FIG. 2 to form two distinct circuits between the generator 104B and the rotor blade 112B. The example blade heating apparatus 200, as mentioned above, may consist of any number of heating circuits.

The example first switch circuitry 108A transfers current from the first solenoid 202A to the example first heating element 116A when in a closed state and does not transfer current when in an open state. Similarly, the example second switch circuitry 108B transfers current from the second solenoid 202B to the example second heating element 116B. The example first switch circuitry 108A and example second switch circuitry 108B may transition between open and closed states based on a control signal.

Both the first heating element 116A and second heating element 116B are embedded within the example rotor blade 112B of FIG. 2. The first heating element 116A and second heating element 116B, or any additional heating elements, if more heating circuits are employed, may be oriented or positioned in any manner within the example rotor blade 112B. For example, the first heating element 116A may be located at the base of the rotor blade 112B and the second heating element 116B may be located at the tip of the rotor blade 112B. Additionally or alternatively, the first heating element 116A may be located near a first side of the rotor blade facing away from the body of the aircraft and the second heating element 116B may be located near a second side of the rotor blade facing towards the body of the aircraft. If employed, additional heating elements of additional heating circuits, can be located depending on the need for anti-icing action distribution and/or intensity. In some examples, the heating elements may overlap in a configuration that maintains electrical insulation between the heating circuits.

The example blade heating apparatus 200 of FIG. 2 illustrates how examples disclosed herein may support any number of heating elements 116A, 116B, . . . , 116-n within a rotor blade. As a result, the example blade heating apparatus may include any number of switch circuitry 108A, 108B, . . . , 108-n instances such that each switch circuitry provides current to a corresponding heating element. By using multiple heating elements 116A, 116B, . . . , 116-n, example controller circuitry 110 may determine which regions of the blade receive heat and/or provide granularity to the amount of temperature variation within the rotor blade.

FIG. 3 is an example implementation of a generator 104B used in the example blade heating apparatus 200 of FIG. 2. The generator 104B includes an example stator 302 and an example rotor 304. The example stator 302 includes example magnets 306A, 306B. The example rotor 304 includes the example first solenoid 202A and the example second solenoid 202B.

The example stator 302 of FIG. 3 is a mechanical fixture attached or being a part of an engine static structure. The example stator 302 is stationary in the sense that its position and orientation do not change relative to the rest of the aircraft. In some examples, the example stator 302 may be affixed to the nacelle of the engine 102. In other examples, the example stator 302 is affixed elsewhere in the aircraft.

The example stator 302 includes magnets 306A, 306B. The magnets 306A, 306B may be attached to the stator 302 by any means. The magnets 306A, 306B are positioned on or within the stator 302 so that the magnetic poles alternate as one or more solenoids rotate around the stator 302. In FIG. 3, the example stator 302 is illustrated with two magnets 306A, 306B and a total of four magnetic poles for simplicity. In practice, any number of magnets 306A, 306B, . . . , 306-n may be positioned within or on the stator 302. An example manufacturer may alter the number of magnets 306A, 306B, . . . , 306-n to change the strength of the corresponding magnetic field, for example.

The example rotor 304 of FIG. 3 is a body that is mechanically connected to the engine 102 in a manner that causes the body to rotate. In some examples, the example rotor 304 may be affixed to a rotating body of the engine 102 such as a fan rotor, propeller shaft, compressor rotor, or any other rotating structure of the engine. In other examples, the example rotor 304 is affixed elsewhere. The example rotor 304 and example stator 302 are positioned so that the example rotor 304 rotates circumferentially around the magnets 306A, 306B on or within the stator 302.

The example first solenoid 202A and example second solenoid 202B of FIG. 3 are coils of wire. In some examples, the coils may be wrapped around the rotor 304. In such examples, the diameter of the coil may be determined by the width of the rotor 304. The example first solenoid 202A and the example second solenoid 202B may be of any length. An example manufacturer may alter the dimensions (e.g., the diameter, length, number of turns in the coil, gage of wire, etc.) of one or more of the first solenoid 202A and the second solenoid 202B to influence the performance of the one or more solenoids. Each of the example first solenoid 202A and the example second solenoid 202B have a positive terminal and a negative terminal that indicate how current flows through the respective circuit (e.g., from the positive terminal, through a switch circuitry, through a heating element, and back to the negative terminal).

When the example rotor 304 rotates around or inside the example stator 302, the example first solenoid 202A and the example second solenoid 202B change position within the magnetic fields produced by the magnets 306A, 306B. This movement of a solenoid through the magnetic field causes electrons within the solenoid to move relative to the coil, inducing electricity. In certain examples, the generator 104B uses a brushless architecture as illustrated in FIG. 3 to help eliminate friction and increase durability when compared to a brushed architecture. In some examples, however, the example generator 104B may be implemented with a brushed architecture.

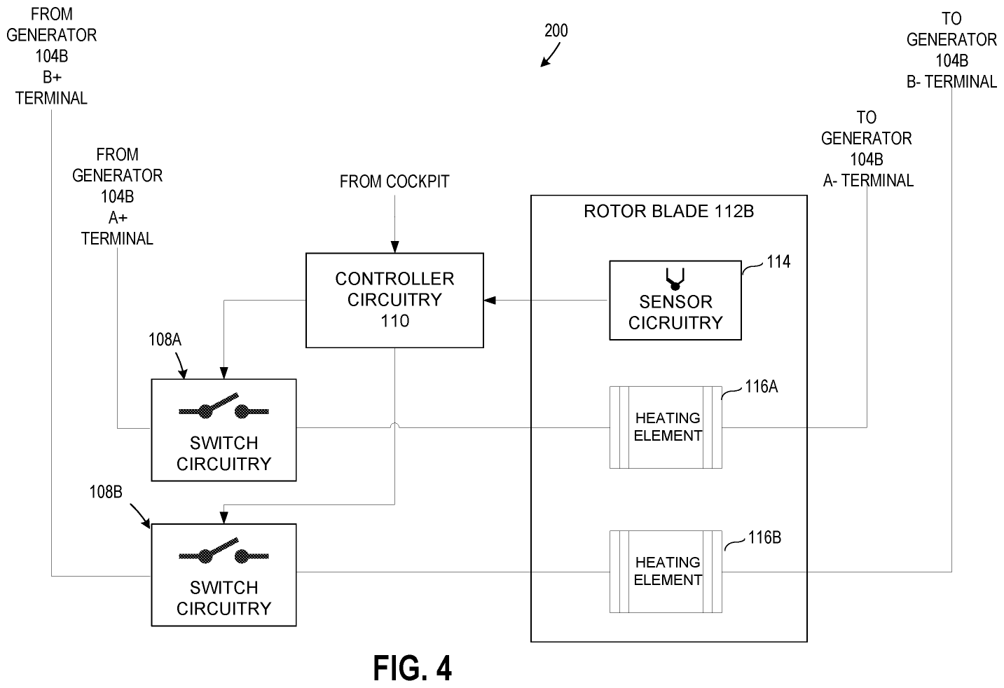

FIG. 4 is a block diagram of an example implementation of the example blade heating apparatus 200. FIG. 4 includes the rotor blade 112B, first heating element 116A, first switch circuitry 108A, second switch circuitry 108B, second heating element 116B, and example controller circuitry 110. FIG. 4 illustrates two example heating circuits for simplicity. The blade heating apparatus 200, however, may include any number of heating circuits including solenoid 202-n, switch circuitry 108-n, heating element 116-n.

The example first solenoid 202A and the example second solenoid 202B allow the example blade heating apparatus 200 of FIG. 2 to form two distinct circuits between the generator 104B and the rotor blade 112B. In the first circuit, current flows from the A+ terminal of the generator 104B, through the switch circuitry 108A when the example controller circuitry 110 sets the switch circuitry 108A in the closed state, through the heating element 116A, and back to the A− terminal of the generator 104B. When the example controller circuitry 110 sets the switch circuitry 108A in the open state, current does not flow through the first circuit and the heating element 116A is powered off

The second circuit of FIG. 4 functions similarly but independent to the first circuit. In the second circuit, current flows from the B+ terminal of the generator 104B, through the switch circuitry 108B when the example controller circuitry 110 sets it in the closed state, through the heating element 116B, and back to the B− terminal of the generator 104B. When the example controller circuitry 110 sets the switch circuitry 108B in the open state, current does not flow through the first circuit and the heating element 116B is powered off. By implementing two independent circuits, the example blade heating apparatus 200 of FIGS. 2-4 allows the example controller circuitry 110 to determine which regions of the blade receive heat and/or provide granularity to the amount of temperature variation within the rotor blade. In examples where the blade heating apparatus 200 implements additional heating circuits, the additional heating circuits may function independently and similarly to the first and second circuits.

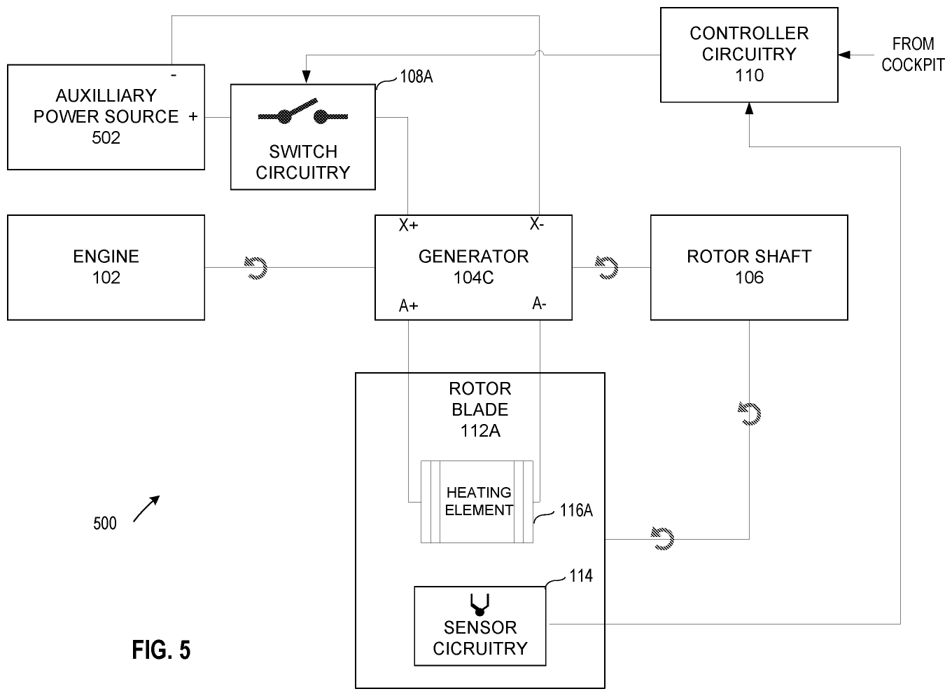

FIG. 5 is a block diagram of a third example implementation of an example blade heating apparatus 500. The example blade heating apparatus 500 of FIG. 5 includes the engine 102, an example auxiliary power source 502, the example switch circuitry 108A, an example generator 104C, the example rotor shaft 106, the example rotor blade 112A, and the example controller circuitry 110. The example rotor blade 112A includes the example sensor circuitry 114 and example heating element 116A.

Like the example blade heating apparatus 100, 200 implementations, the example blade heating apparatus 500 includes a generator that uses the rotational energy of the engine 102 to produce electricity. Similarly, a generator transfers current to one or more heating elements 116A, 116B, . . . , 116-n via wires and rotational energy to the rotor blade via the rotor shaft 106 in all three example implementations of the example blade heating apparatus. Finally, the example controller circuitry 110 opens or closes one or more of the switch circuitry 108A, 108B, . . . , 108-n instances based on input from one or more of the sensor circuitry 114 and a user in a cockpit in all three example implementations.

The auxiliary power source 502 of FIG. 5 provides electricity to the switch circuitry 108A. The auxiliary power source 502 may be any power source that can provide electricity. In some examples, the auxiliary power source 502 is a battery. In other examples, the auxiliary power source 502 is a second generator that is connected to engine 102.

As described in FIG. 1 in connection with the example blade heating apparatus 100, the switch circuitry 108A of the example blade heating apparatus 500 receives electricity from the auxiliary power source 502. In the closed state, current flows from the switch circuitry 108A to the generator 104C. In the open state, current does not flow through the switch circuitry 108A. The switch circuitry 108A of FIG. 5 may be any type of switch, including but not limited to a reed switch.

The example blading heating apparatus 500 of FIG. 5 implements a generator 104C that uses electromagnets 602A, 602B. Electromagnets are materials that only generate a magnetic field when a current runs through them. By using electromagnets, the example blade heating apparatus 500 of FIG. 5 is implemented with current flowing through the switch circuitry 108A before the generator 104C. This contrasts the example blade heating apparatus 100, 200 implementations where current flows through one or more switch circuitry 108A, 108B, . . . , 108-n instances after the generator 104C. When the switch circuitry 108A of FIG. 5 is open, the heating element 116A is not active because the generator 104C is not producing electricity. Furthermore, when the switch circuitry 108A of FIG. 5 is closed, the auxiliary power source 502 provides electricity to the generator 104C in a first circuit. Electricity from the auxiliary power source 502 causes the electromagnets 602A, 602B to generate a magnetic field and complete a second circuit that heats the rotor blade. In such examples, the first circuit and the second circuit may be electrically isolated.

FIG. 6 is a block diagram of the example generator 104C implemented according to the example of FIG. 5. The generator 104C includes a rotor 304 and a stator 302. The rotor 304 includes a first solenoid 202A and the stator includes electromagnets 602A, 602B.

Like the example generator 104C of FIG. 3, the rotor 304 of FIG. 6 rotates from a mechanical connection to the engine 102. Like FIG. 3, the first solenoid 202A produces electricity when rotating in a magnetic field. Similarly, the position and orientation of the stator 302 does not change relative to the aircraft, as seen in FIG. 3.

The electromagnets 602A, 602B of FIG. 6 may be implemented by wrapping a wire into a coil. The electromagnets receive current from the auxiliary power source 502 at the positive terminal (e.g., X+) of the coil and provide current back to the auxiliary power source 502 at the negative terminal (e.g., X−). When the current flows through the coil, the electromagnets 602A, 602B generate a magnetic field that in turn generates a current in the first solenoid 202A. The coil may be wrapped around various portions of the stator 302. In such examples, the stator 302 may be made from a ferromagnetic material to concentrate the magnetic flux and increase the strength of the electromagnets 602A, 602B. FIG. 6 may illustrate two electromagnets 602A, 602B for simplicity. In practice, the example stator 302 may include any number of electromagnets.

The example generator 104C of FIG. 6 allows the example blade heating apparatus 500 to control the heating element 116A via switch circuitry 108A placed before the generator 104C, as opposed to placing the switch circuitry 108A after the generator 104A as described in FIG. 1. An example manufacturer may choose where to implement a switch circuitry and how to implement a generator based on factors including but not limited to build cost, configuration of the aircraft, etc.

While an example manner of implementing the example blade heating apparatus 100, 200, 500 of FIGS. 1, 2, 5 are illustrated in FIGS. 1-6, one or more of the elements, processes, and/or devices illustrated in FIGS. 1-6 may be combined, divided, re-arranged, omitted, eliminated, and/or implemented in any other way. Further, the example controller circuitry 110 of FIG. 1 may be implemented by hardware alone or by hardware in combination with software and/or firmware. Thus, for example, the example controller circuitry 110 of FIG. 1 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example controller circuitry 110 of FIG. 1 may include one or more elements, processes, and/or devices in addition to, or instead of, those illustrated in FIGS. 2-6, and/or may include more than one of any or all of the illustrated elements, processes and devices.

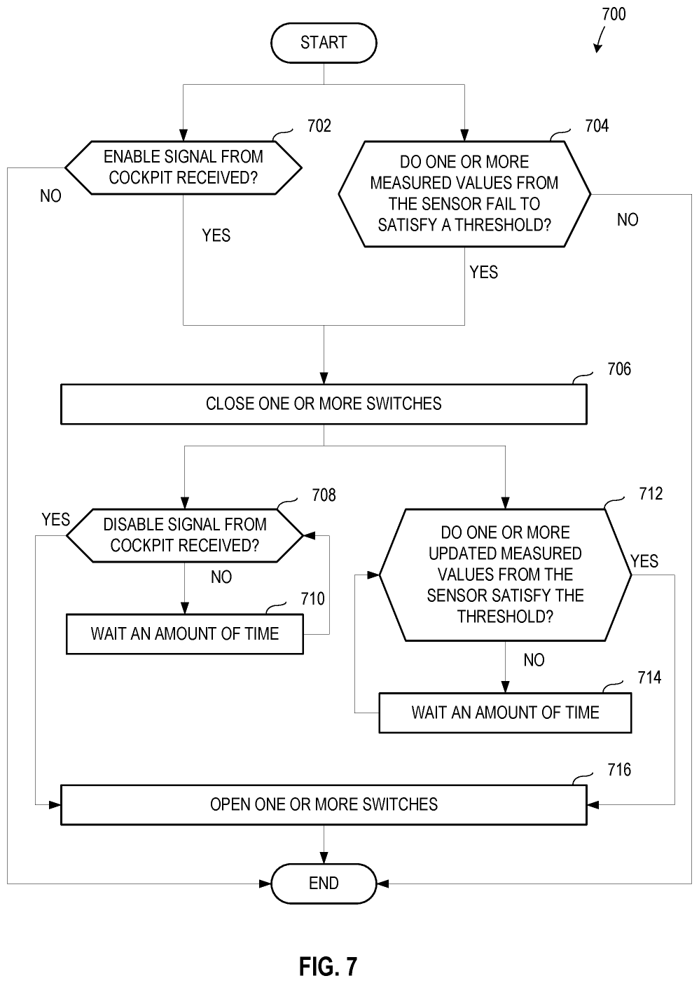

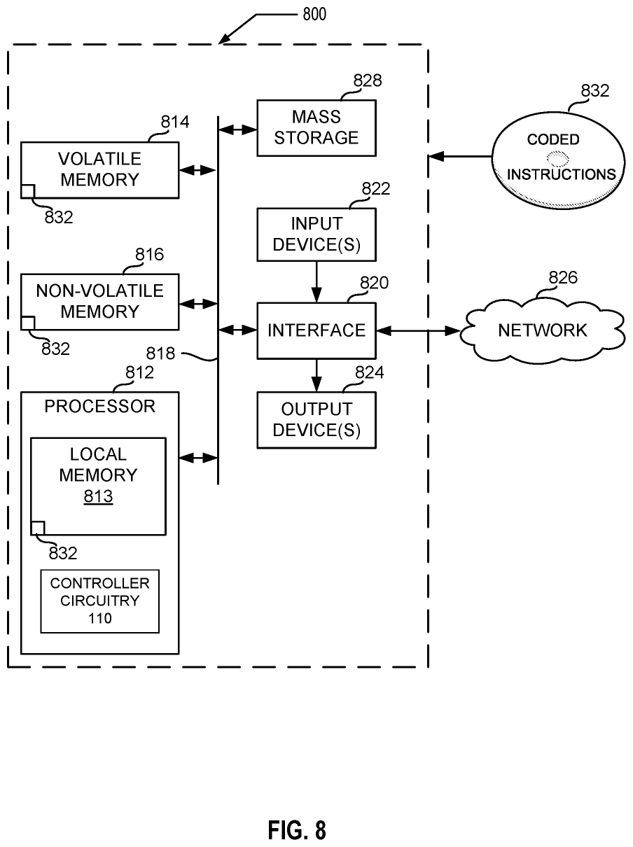

A flowchart representative of example hardware logic circuitry, machine readable instructions, hardware implemented state machines, and/or any combination thereof for implementing the controller circuitry 110 of FIG. 1 is shown in FIG. 7. The machine readable instructions may be one or more executable programs or portion(s) of an executable program for execution by processor circuitry, such as the processor circuitry 812 shown in the example processor platform 800 discussed below in connection with FIG. 8. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 7, many other methods of implementing the example controller circuitry 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, and/or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed and/or instantiated by processor circuitry 812 to control one or more switch circuitry 108A, 108B, . . . , 108-n instances of any example blade heating apparatus 100, 200, 500. The machine readable instructions and/or the operations 700 of FIG. 7 may begin when the one or more example switch circuitry 108A, 108B, . . . , 108-n instances are in an open state and the corresponding one or more example heating elements 116A, 116B, . . . , 116-n are disabled.

The example controller circuitry 110 may determine whether an enable signal was received from the cockpit. (Block 702). The enable signal may be generated by a user (e.g., a pilot) in the cockpit, or be generated by an aircraft system, for any reason. For example, a user or an aircraft system may generate an enable signal in response to the aircraft entering a certain altitude or experiencing certain weather conditions such as precipitation, humidity, wind, etc. In other examples, a user or an aircraft system may generate an enable signal at periodic time intervals, when entering a geographic region, or in response to receiving information from a third party such as a control tower.

Additionally or alternatively to block 702, the example controller circuitry 110 may determine whether one or more measured value from the sensor circuitry 114 fails to satisfy a threshold. (Block 704). The threshold may be any set or range of values that, when measured by the sensor circuitry 114, may prevent the formation or accumulation of ice on the rotor blade 112A or rotor blade 112B. For example, if the sensor circuitry 114 measures one or more temperature values corresponding to the rotor blade 112A or rotor blade 112B, the example controller circuitry 110 may determine that the values fail to satisfy the threshold when the average of the one or more temperatures is less than or equal to a threshold temperature. In other examples, the sensor circuitry 114 may determine the values fail to satisfy the threshold when the lowest measured temperature of the one or more temperatures is less than or equal to the threshold temperature, or when certain temperatures corresponding to specified regions of the rotor blade 112A or rotor blade 112B are less than or equal to the threshold temperature. In such examples, the threshold temperature is a pre-determined minimum temperature set such that temperatures below the threshold temperature may indicate the formation or accumulation of ice is possible. In other examples, the sensor circuitry 114 may measure parameters other than temperature that correspond to the rotor blade 112A or rotor blade 112B.

If the example controller circuitry 110 does not receive an enable signal at block 702 and/or if one or more measured values from the sensor circuitry 114 satisfy the threshold of block 704, the example machine readable instructions and/or operations 700 end. If the example controller circuitry 110 does receive an enable signal at block 702, or if one or more measured values from the sensor circuitry 114 fail to satisfy the threshold of block 704, the example controller circuitry 110 closes one or more switch circuitry 108A, 108B, . . . , 108-n instances. (Block 706). In some examples, the rotor blade 112A includes a single heating element 116A and the example controller circuitry 110 closes a single switch circuitry 108A instance corresponding to the heating element 116A. In other examples, the rotor blade 112B includes a plurality of heating elements 116A, 116B, . . . , 116-n. In such examples, the example controller circuitry 110 may determine which of the corresponding switch circuitry 108A, 108B, . . . , 108-n instances to close based on the enable signal and/or the one or more measured values. For example, if the plurality of heating elements 116A, 116B, . . . , 116-n correspond to various regions of the rotor blade 112B, the example controller circuitry 110 may close the switch circuitry 108A, 108B instances corresponding to the heating elements 116A, 116B whose measured temperature value was below the threshold temperature values and keep the switch circuitry 108C, . . . , 108-n instances corresponding to the remaining heating elements 116C, . . . , 116-n open. When the one or more switch circuitry 108A, 108B, . . . , 108-n instances are closed, current flows through the one or more heating elements 116A, 116B, . . . , 116-n and heats the rotor blade 112B.

The example controller circuitry 110 determines whether a disable signal was received from the cockpit. (Block 708). The disable signal may be generated by a user (e.g., a pilot) in the cockpit, or be generated by an aircraft system, for any reason. In some examples, the disable signal may correspond to the enable signal received at block 702. In one example, when an enable signal was generated when the aircraft entered certain weather conditions (e.g., temperature, precipitation, humidity, wind, etc.), a disable signal may be generated when the aircraft exits said weather conditions. In a second example, when an enable signal is generated at certain times, the disable signal may be periodically generated at corresponding times such that a heating element is powered on for a certain time interval and powered off for a certain time interval. In a third example, when an enable signal was generated in response to first information received from a control tower, a disable signal may be generated in response to second information received from the control tower. In other examples, the disable signal may be related to the threshold of block 704. In other examples, the disable signal may be generated independently from previous inputs.

When a disable signal is not received from the cockpit, the example controller circuitry 110 may wait an amount of time. (Block 710). In some examples, the amount of time may be a value pre-determined by a manufacturer. When the amount of time has passed, the example machine readable instructions and/or operations 700 may return to block 708.

Additionally or alternatively, the example controller circuitry 110 may determine whether one or more updated measured values from the sensor circuitry 114 satisfy the threshold of block 704. (Block 712). For example, when a plurality of heating elements 116A, 116B, . . . , 116-n correspond to various regions of the rotor blade 112B and a subset of the heating elements 116A, 116B are powered on, the example controller circuitry 110 may determine which of the corresponding updated measured temperatures are greater than the threshold temperature. In other examples, the sensor circuitry 114 may generate a single temperature value for all of the rotor blade 112A or rotor blade 112B and the example controller circuitry 110 determines if the updated temperature value is greater than the threshold temperature. In other examples, the threshold of block 704 may be a set of values such that one or more of the switch circuitry 108A, 108B, . . . , 108-n instances are closed when the measured temperature is below a first threshold value but open when the measured temperature is above a second temperature. In other examples, the sensor circuitry 114 may additionally or alternatively measure a parameter corresponding to the rotor blade 112A or rotor blade 112B other than temperature. In other examples, the example controller circuitry 110 may make the determination of block 712 based on a signal from the cockpit.

When one or more updated measured values fail to satisfy the threshold of block 704, the example controller circuitry 110 may wait an amount of time. (Block 714). The amount of time may be a value pre-determined by a manufacturer. When the amount of time has passed, the example machine readable instructions and/or operations 700 may return to block 712.

When a disable signal is received from the cockpit at block 708, or one or more updated measured values satisfy the threshold at block 712, the example controller circuitry 110 opens one or more of the switch circuitry 108A, 108B, . . . , 108-n instances. (Block 716). The example controller circuitry 110 may determine which of the one or more closed switches to open based on information in the disable signal or the updated measured values. In some examples, the example controller circuitry 110 may open all of the switch circuitry 108A, 108B, . . . , 108-n instances that were closed at block 706. In other examples, the example controller circuitry 110 may open a subset of the switch circuitry 108A, 108B, . . . , 108-n instances that were closed at block 706. For example, if three measured values failed to satisfy the threshold at block 704 and two of the three updated measured values satisfy the threshold at block 712, the example controller circuitry 110 may open two switch circuitry 108A, 108B, . . . , 108-n instances that correspond to the newly satisfied measured values. The example machine readable instructions and/or operations 700 end after block 716.

FIG. 8 is a block diagram of an example processor platform 800 structured to execute and/or instantiate the machine readable instructions and/or the operations of FIG. 7 to implement the example controller circuitry 110 of FIG. 1. The processor platform 800 can be, for example, a server, a personal computer, a workstation, a self-learning machine (e.g., a neural network), a mobile device (e.g., a cell phone, a smart phone, a tablet such as an iPad™, a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs, microprocessors, CPUs, GPUs, DSPs, and/or microcontrollers from any desired family or manufacturer. The processor circuitry 812 may be implemented by one or more semiconductor based (e.g., silicon based) devices. In this example, the processor circuitry 812 implements the example controller circuitry 110.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 832, which may be implemented by the machine readable instructions of FIG. 7, may be stored in the mass storage device 828, in the volatile memory 814, in the non-volatile memory 816, and/or on a removable non-transitory computer readable storage medium such as a CD or DVD.

FIG. 9A-9C are illustrative examples of a rotor blade of any of the example blade heating apparatus 100, 200, 500. The example rotor blade 900 may be an example implementation of the rotor blade 112A and/or rotor blade 112B. The rotor blade 900 includes an inner composite layer 902, outer composite layer 904 and the example heating element 116A. FIG. 9A-9C illustrates a single heating element 116A for simplicity. The example rotor blade 900, however, may implement any number of heating elements. Multiple heating elements may be placed between the same composite layers, or between various composite layers. In some examples, multiple heating elements may overlap. In such examples, the multiple heating elements may be configured in a matter that maintains electric insulation between the elements.

The rotor blade 900 may be formed out of multiple composite layers. The composite materials used to form the layers may include but are not limited to carbon, glass, plastics, metals, wood, etc. In many aircrafts, the composite layers may include carbon fibers due to their advantageous properties such as high tensile strength, high stiffness, low weight, low thermal expansion, etc.

Because a single layer of composite material can have a thickness of millimeters or smaller, the rotor blade 900 may be composed of multiple composite layers to achieve desired airfoil and aerodynamic properties. In such examples, the heating element 116A may be placed in between the inner composite layer 902 and the outer composite layer 904 during the manufacturing process. As used herein, inner may refer the portion of the rotor blade 900 that is closest to the body of the aircraft, while outer may refer to the portion of the rotor blade 900 that is furthest from the body of the aircraft and therefore exposed to the most environmental conditions. In FIG. 9A, the outer composite layer 904 is peeled back partially to show where the heating element 116A may be located and to show that the heating element 116A would not be directly exposed to environmental conditions. The example rotor blade 900 may include a single heating element 116A as shown in FIGS. 9A-9C and implemented by the rotor blade 112A, or may include a plurality of heating elements 116A, 116B, . . . , 116-n as implemented by the rotor blade 112B.

FIG. 9B includes heating element 116A, inner composite layer 902, outer composite layer 904, and a mold tool 906. In some examples, the mold tool 906 may be used to form a composite layer into a specific shape. The mold tool 906 may also be used to hold the composite layers in place while a resin or other adhesive is applied. As shown in FIG. 9A, the heating element 116A may be placed in between the inner composite layer 902 and the outer composite layer 904.

FIG. 9C shows a cross sectional view of a rotor blade 900. In such a view, the heating element 116A may appear as circles that represent wires travelling the length (span) of the rotor blade 900. The ratio of the diameter of the heating element 116A to the thickness of the rotor blade 900 may be exaggerated in FIG. 8C to provide visual clarity. In reality, the wire gage used in the heating element 116A may be smaller.

Furthermore, FIG. 9C illustrates the rotor blade 900 with three composite layers for simplicity. In practice, the rotor blade 900 may be formed out of any number of composite materials. As such, the one or more additional composite layers may be placed between the heating element 116A and the inner composite layer 902 and/or the outer composite layer 904 such that one or more aerodynamic properties of the rotor blade 900 may be unaltered by the presence of the heating element 116A.

From the foregoing, it will be appreciated that example systems, methods, apparatus, and articles of manufacture have been disclosed that generate electricity to heat a rotor blade using a heating element embedded in the rotor blade. Disclosed systems, methods, apparatus, and articles of manufacture improve the efficiency of using a computing device as a controller by closing switch circuitry to conditionally allow current to flow through the heating element. Disclosed systems, methods, apparatus, and articles of manufacture are accordingly directed to one or more improvement(s) in the operation of an engine with improved temperature regulation of associated rotor blades.

Example methods, apparatus, systems, and articles of manufacture to heat a rotor blade are disclosed herein. Further examples and combinations thereof include the following.

Example 1 includes a blade heating apparatus comprising a stationary magnet, a solenoid to rotate around the stationary magnet, the rotation to generate electricity using the solenoid, and a heating element embedded in a rotor blade, the heating element to increase a temperature of the rotor blade using the electricity.

Example 2 includes the blade heating apparatus of any preceding clause, wherein the solenoid and the stationary magnet are components of a brushless generator, wherein the electricity generated by the brushless generator is direct current.

Example 3 includes the blade heating apparatus of any preceding clause, wherein the solenoid is attached to a rotor, an engine is to rotate the rotor, and the rotor is a fan rotor, an open rotor, a propeller shaft, or a compressor rotor associated with the engine.

Example 4 includes the blade heating apparatus of any preceding clause, further including a switch between the solenoid and the heating element, and controller circuitry to open or close the switch, wherein the heating element receives the electricity when the switch is closed.

Example 5 includes the blade heating apparatus of any preceding clause, wherein the controller circuitry is further to close the switch in response to receiving an enable signal, and open the switch in response to receiving a disable signal.

Example 6 includes the blade heating apparatus of any preceding clause, further including a temperature sensor to measure the temperature of the rotor blade.

Example 7 includes the blade heating apparatus of any preceding clause, wherein the controller circuitry is to close the switch in response to a determination that the measured temperature is below a first threshold value, and open the switch in response to a determination that the measured temperature is above a second threshold value.

Example 8 includes the blade heating apparatus of any preceding clause, wherein the stationary magnet is an electromagnet, further including a switch between an auxiliary power source and the electromagnet, and controller circuitry to open or close the switch, wherein the heating element receives the electricity when the switch is closed.

Example 9 includes the blade heating apparatus of any preceding clause, wherein the rotor blade includes a first composite layer and a second composite layer, wherein the heating element is located above the first composite layer and below the second composite layer such that one or more aerodynamic properties of the rotor blade is unaltered by the heating element.

Example 10 includes a method to heat a rotor blade comprising rotating a rotor around a stationary magnet, attaching a solenoid to the rotor, the rotation to generate electricity using the solenoid, and embedding a heating element in a rotor blade, the heating element to increase a temperature of the rotor blade using the electricity.

Example 11 includes the method of any preceding clause, wherein the solenoid, the stationary magnet, and the rotor are components of a brushless generator, further including generating the electricity as direct current.

Example 12 includes the method of any preceding clause, wherein the rotor is a fan rotor or a compressor rotor associated with an engine.

Example 13 includes the method of any preceding clause, further including implementing a switch between the solenoid and the heating element, and opening or closing the switch, wherein the heating element receives the electricity when the switch is closed.

Example 14 includes the method of any preceding clause, further including closing the switch in response to receiving an enable signal, and opening the switch in response to receiving a disable signal.

Example 15 includes the method of any preceding clause, further including measuring the temperature of the rotor blade.

Example 16 includes the method of any preceding clause, further including closing the switch in response to a determination that the measured temperature is below a first threshold value, and opening the switch in response to a determination that the measured temperature is above a second threshold value.

Example 17 includes the method of any preceding clause, wherein the rotor blade includes a first composite layer and a second composite layer, further including embedding the heating element above the first composite layer and below the second composite layer such that one or more aerodynamic properties of the rotor blade is unaltered by the heating element.

Example 18 includes a blade heating apparatus comprising a rotor to rotate around a stationary magnet, a first solenoid attached to the rotor, a second solenoid attached to the rotor, the rotation to generate electricity using the first solenoid and the second solenoid, and a first heating element in a rotor blade, and a second heating element embedded in the rotor blade, the first heating element and the second heating element to increase a temperature of the rotor blade using the electricity.

Example 19 includes the blade heating apparatus of any preceding clause, wherein the first solenoid provides a first current to the first heating element as part of a first circuit, the second solenoid provides a second current to the second heating element as a part of a second circuit, and the first circuit is electrically isolated from the second circuit.

Example 20 includes the blade heating apparatus of any preceding clause, wherein the rotor, the stationary magnet, the first solenoid and the second solenoid are components of a generator, wherein the generator is a brushless generator that generates direct current.

Example 21 includes the blade heating apparatus of any preceding clause, further including a first switch between the first solenoid and the first heating element, a second switch between the second solenoid and the second heating element, and controller circuitry to open or close one or more of the first switch and the second switch.

Example 22 includes the blade heating apparatus of any preceding clause, wherein the blade heating apparatus further includes sensor circuitry to determine a first temperature value corresponding to the first heating element, and determine a second temperature value corresponding to the second heating element, and the controller circuitry is to close or open the first switch based on the first temperature, and close or open the second temperature.

Example 23 includes the blade heating apparatus of any preceding clause, wherein the controller circuitry is to close the first switch and the second switch in response to receiving an enable signal, and open the first switch and the second switch in response to receiving a disable signal.

Example 24 includes a blade heating apparatus comprising a rotor to rotate around a stationary electromagnet, a solenoid attached to the rotor, the rotation to generate electricity using the solenoid, and a heating element embedded in a rotor blade, the heating element to increase a temperature of the rotor blade using the electricity.

Example 25 includes the blade heating apparatus of any preceding clause, wherein the solenoid and the electromagnet form a generator as part of a first circuit to power the heating element, the electromagnet is powered by an auxiliary power source as part of a second circuit, and the first circuit is electrically isolated from the second circuit.

Example 26 includes the blade heating apparatus of any preceding clause, further including an engine to rotate the rotor, wherein the first circuit is powered by the engine.

Example 27 includes the blade heating apparatus of any preceding clause, wherein the generator is a brushless generator that generates direct current.

Example 28 includes the blade heating apparatus of any preceding clause, further including a switch between the solenoid and the heating element, and controller circuitry to open or close the switch, wherein the heating element receives the electricity when the switch is closed.

Example 29 includes the blade heating apparatus of any preceding clause, wherein the controller circuitry is opened or closed due to an environmental condition, the environmental condition to include one or more of temperature, humidity, precipitation, or wind.

The following claims are hereby incorporated into this Detailed Description by this reference. Although certain systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A blade heating apparatus comprising:
a stationary magnet;
a solenoid to rotate around the stationary magnet, the rotation to generate electricity using the solenoid; and
a heating element embedded in a rotor blade, the heating element to increase a temperature of the rotor blade using the electricity.

2. The blade heating apparatus of claim 1, wherein the solenoid and the stationary magnet are components of a brushless generator, wherein the electricity generated by the brushless generator is direct current.

3. The blade heating apparatus of claim 1, wherein:
the solenoid is attached to a rotor;
an engine is to rotate the rotor; and
the rotor is a fan rotor, an open rotor, a propeller shaft, or a compressor rotor associated with the engine.

4. The blade heating apparatus of claim 1, further including:
a switch between the solenoid and the heating element; and
controller circuitry to open or close the switch, wherein the heating element receives the electricity when the switch is closed.

5. The blade heating apparatus of claim 4, wherein the controller circuitry is further to:
close the switch in response to receiving an enable signal; and
open the switch in response to receiving a disable signal.

6. The blade heating apparatus of claim 4, further including a temperature sensor to measure the temperature of the rotor blade.

7. The blade heating apparatus of claim 6, wherein the controller circuitry is to:
close the switch in response to a determination that the measured temperature is below a first threshold value; and
open the switch in response to a determination that the measured temperature is above a second threshold value.

8. The blade heating apparatus of claim 1, wherein the stationary magnet is an electromagnet, further including:
a switch between an auxiliary power source and the electromagnet; and
controller circuitry to open or close the switch, wherein the heating element receives the electricity when the switch is closed.

9. The blade heating apparatus of claim 1, wherein the rotor blade includes a first composite layer and a second composite layer, wherein the heating element is located above the first composite layer and below the second composite layer such that one or more aerodynamic properties of the rotor blade is unaltered by the heating element.

10. A method to heat a rotor blade comprising:
rotating a rotor around a stationary magnet;
attaching a solenoid to the rotor, the rotation to generate electricity using the solenoid; and
embedding a heating element in a rotor blade, the heating element to increase a temperature of the rotor blade using the electricity.

11. The method of claim 10, wherein the solenoid, the stationary magnet, and the rotor are components of a brushless generator, further including generating the electricity as direct current.

12. The method of claim 10, wherein the rotor is a fan rotor or a compressor rotor associated with an engine.

13. The method of claim 10, further including:
implementing a switch between the solenoid and the heating element; and
opening or closing the switch, wherein the heating element receives the electricity when the switch is closed.

14. The method of claim 13, further including:
closing the switch in response to receiving an enable signal; and
opening the switch in response to receiving a disable signal.

15. The method of claim 13, further including measuring the temperature of the rotor blade.

16. The method of claim 15, further including:
closing the switch in response to a determination that the measured temperature is below a first threshold value; and
opening the switch in response to a determination that the measured temperature is above a second threshold value.

17. The method of claim 10, wherein the rotor blade includes a first composite layer and a second composite layer, further including embedding the heating element above the first composite layer and below the second composite layer such that one or more aerodynamic properties of the rotor blade is unaltered by the heating element.

18. A blade heating apparatus comprising:
a rotor to rotate around a stationary magnet;
a first solenoid attached to the rotor;
a second solenoid attached to the rotor; the rotation to generate electricity using the first solenoid and the second solenoid; and
a first heating element in a rotor blade; and
a second heating element embedded in the rotor blade, the first heating element and the second heating element to increase a temperature of the rotor blade using the electricity.

19. The blade heating apparatus of claim 18, wherein:
the first solenoid provides a first current to the first heating element as part of a first circuit;
the second solenoid provides a second current to the second heating element as a part of a second circuit; and
the first circuit is electrically isolated from the second circuit.

20. The blade heating apparatus of claim 18, wherein the rotor, the stationary magnet, the first solenoid and the second solenoid are components of a generator, wherein the generator is a brushless generator that generates direct current.
